(19) United States
(12) Patent Application Publication
(10) Pub. No.: US 2020/0023698 A1
(43) Pub. Date: Jan. 23, 2020

(54) TRAILER LOCK STRUCTURE

(71) Applicant: HANDYWAY CO., LTD., Changhua (TW)

(72) Inventor: Chin-Hui TSAI, Changhua (TW)

(21) Appl. No.: 16/037,971

(22) Filed: Jul. 17, 2018

(51) Int. Cl. B60D 1/60

(52) U.S. Cl. CPC B60D 1/60

(57) ABSTRACT

A trailer lock structure, which includes a body, a lock barrel set and a latch set, wherein a fitting portion is set on the upper side of the body, a latch insertion hole and a rabbet are set on the fitting portion, a latch mounting base and a horizontal lock barrel holder are set on the lower side of the body, a first fitting hole is set on the latch mounting base, a second fitting hole is set on the horizontal lock barrel holder, the lock barrel set is installed in the second fitting hole, the latch set is installed in the first fitting hole. By the composition of the above components, the anti-theft capability and the use efficiency of trailer locks would be improved.

### BACKGROUND OF THE INVENTION

### a) Field of the Invention

The invention relates to a trailer lock structure and, more particularly, a trailer lock structure for pickproof function and ease of operation, to thereby improve the anti-theft capability and the use efficiency of trailer locks.

### b) Description of Prior Art

As shown in FIG. 1, which is an appearance three-dimensional schematic diagram of a conventional trailer lock, a fitting portion 12 is set on the upper side of the body 11 of the trailer lock 1, a rabbet 121 is set on the peripheral edge of the fitting portion 12, the rabbet 121 is provided for a trailer coupler (not shown in FIG. 1) to fit and lock, a lock barrel portion 13 is set on the bottom of the fitting portion 12, the lock barrel portion 13 is provided for locking and unlocking operation. Although this kind of structure has already been used, there is an inconvenience in use that the keyhole position of the lock barrel portion 13 is set on the bottom. It is quite inconvenient when a user want to unlock it, because the user have to squat down to see the keyhole. The user could only touch to unlock under normal circumstances, sometimes the key 14 is inserted in a wrong direction and the user often test for a long time, it is not ergonomic. For this reason, the inventor of the present invention has proposed the cited reference TW M515018 to improve the drawback, wherein the keyhole of the lock barrel is moved to horizontal for easy to unlock. But in general, the old techniques that the latch is caught by a still ball is still used in the internal lock structure, there are many components in this conventional structure, so it is complicated in assembly. Moreover, when the trailer lock 1 is impacted by external force, this kind of lock structure that a steel ball is used to catch the latch may be easily picked due to shaking effect.

### SUMMARY OF THE INVENTION

In view of this, the inventor finally completes the trailer lock structure of the present invention after numerous improvements, namely, the object of the present invention is to provide a trailer lock structure for pickproof function and ease of operation, to thereby improve the anti-theft capability and the use efficiency of trailer locks.

To achieve the above object according to the invention, the trailer lock structure of the present invention includes:

a body, a fitting portion is set on its upper side, a latch insertion hole and a rabbet are set on the fitting portion, a latch mounting base and a horizontal lock barrel holder are set on the lower side of the body, a first fitting hole is set on the latch mounting base, the first fitting hole is communicated with the latch insertion hole, a second fitting hole is set on the horizontal lock barrel holder;

a lock barrel set, which is fit in the second fitting hole, the lock barrel set includes a lock barrel, a drive piece and a first spring, a keyhole is set on the outer end of the lock barrel, the keyhole is provided for a key to insert into for unlocking operation, a latch bolt is set on the inner end of the lock barrel, the latch bolt is connected to one end of the drive piece and drives the drive piece to rotate, the other end of the drive piece is pressed by the elasticity of the first spring;

a latch set, which is set in the first fitting hole, the latch set includes a latch, a latch barrel and a second spring; a clip section is set on the upper end of the latch; a limiting section, an actuation section and a pressing section are sequentially set below the clip section; a horizontal hole is set on the limiting section for one end of a fixing bolt to insert into and fix, the actuation section is used to place the drive piece and link up with it; a through hole and a spring mounting hole are set on the latch barrel, the through hole is used to place the latch, the spring mounting hole is used to place the second spring, the bottom end of the second spring is pressed on the fixing bolt.

The above drive piece, wherein a fitting slot is set on its one end, the fitting slot is connected to the latch bolt.

The above drive piece, wherein an actuation groove is set on it.

### BRIEF DESCRIPTION OF THE DRAWINGS

FIG. 1 is an appearance three-dimensional schematic diagram of a conventional trailer lock;

FIG. 2 is a three-dimensional exploded schematic diagram of the present invention;

FIG. 3 is another three-dimensional schematic diagram of the latch barrel of the present invention;

FIG. 4 is a three-dimensional schematic diagram of the present invention;

FIG. 5 is a cross-sectional schematic diagram of the combination of the present invention; and

FIG. 6 is a schematic diagram of embodiment of locking mode of the present invention.

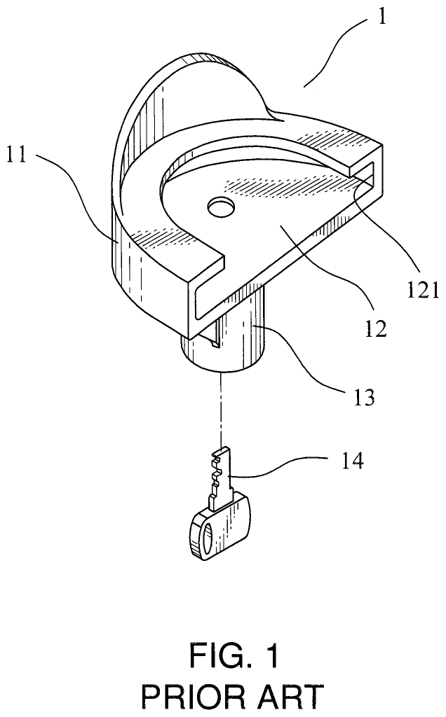

### DETAILED DESCRIPTION OF THE INVENTION

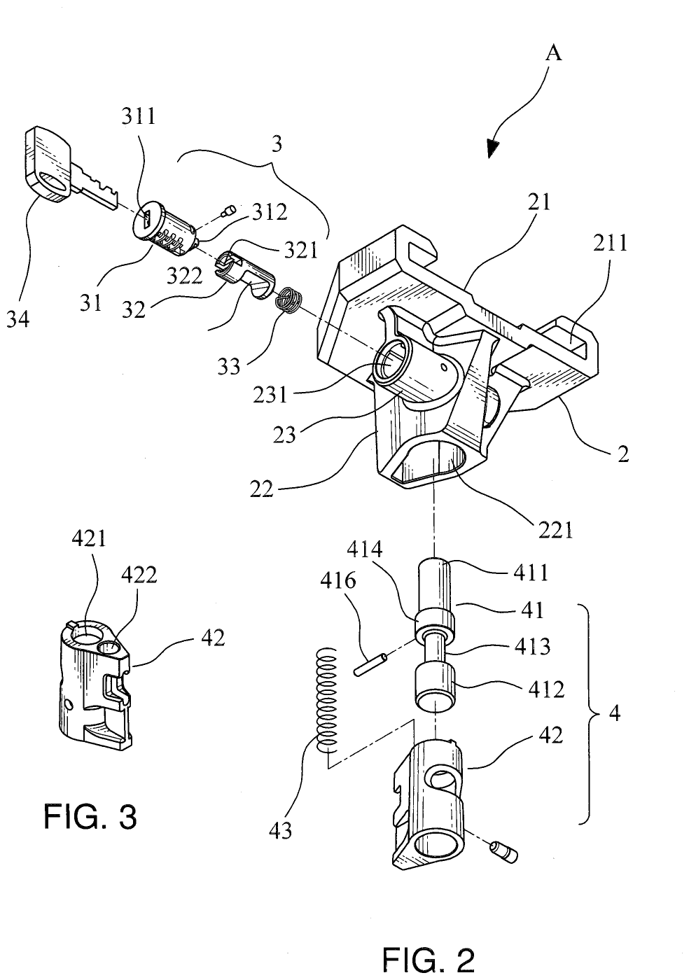

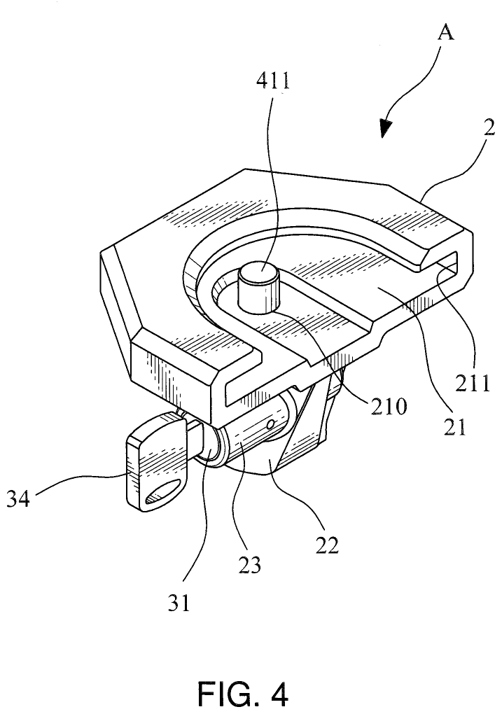

Please refer to FIG. 2 to FIG.5, the trailer lock A of the present invention, including:

a body 2, a fitting portion 21 is set on its upper side, a latch insertion hole 210 and a rabbet 211 are set on the fitting portion 21, a latch mounting base 22 and a horizontal lock barrel holder 23 are set on the lower side of the body 2, a first fitting hole 221 is set on the latch mounting base 22, the first fitting hole 221 is communicated with the latch insertion hole 210, a second fitting hole 231 is set on the horizontal lock barrel holder 23;

a lock barrel set 3, which is fit in the second fitting hole 231, the lock barrel set 3 includes a lock barrel 31, a drive piece 32 and a first spring 33, a keyhole 311 is set on the outer end of the lock barrel 31 (the structure of the lock barrel 31 is prior art, thus it is not disclosed here), the keyhole 311 is provided for a key 34 to insert into for unlocking operation, a latch bolt 312 is set on the inner end of the lock barrel 31, the latch bolt 312 is connected to a fitting slot 321 on one end of the drive piece 32 and drives the drive piece 32 to rotate, the other end of the drive piece 32 is pressed by the elasticity of the first spring 33, an actuation groove 322 is set on the drive piece 32;

a latch set 4, which is set in the first fitting hole 221, the latch set includes a latch 41, a latch barrel 42 and a second spring 43, a clip section 411 is set on the upper end of the latch 41; a limiting section 414, an actuation section 413 and a pressing section 412 are sequentially set below the clip section 411; a horizontal hole 415 is set on the limiting section 414 for one end of a fixing bolt 416 to insert into and fix, the actuation section 413 is used to place the drive piece 32 and link up with it; a through hole 421 and a spring mounting hole 422 are set on the latch barrel 42, the through hole 421 is used to place the latch 41, the spring mounting hole 422 is used to place the second spring 43, the bottom end of the second spring 43 is pressed on the fixing bolt 416.

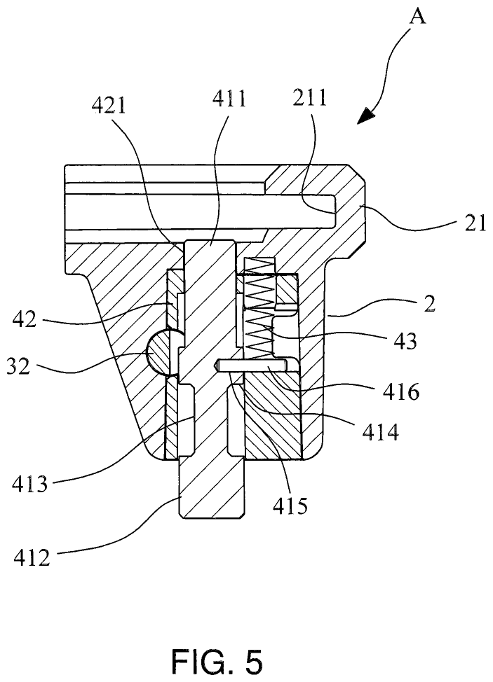

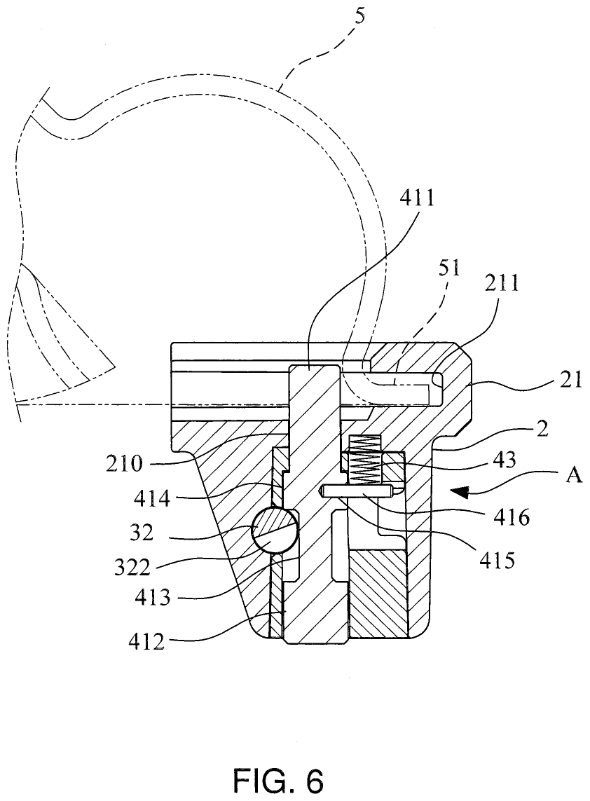

In the trailer lock structure A of the present invention, by the composition of the above elements, when it is unlocked (as shown in FIG. 5), wherein the second spring 43 is expended by the elasticity, the fixing bolt 416 is pressed by the elasticity and the latch 41 is driven to move downwards, the pressing section 412 of the latch 41 is inserted out of the bottom side of the latch barrel 42. When wanting to lock a trailer coupler 5 (as shown in FIG. 6), an user could slip the flange 51 of the trailer coupler 5 into the rabbet 211 of the fitting portion 21 of the trailer lock A and press the pressing section 412 of the latch 41 to let the latch 41 move upwards and press the second spring 43, so that the clip section 411 sticks out of the latch insertion hole 210 and fasten the trailer coupler 5, then the user rotates the lock barrel 31 by the key 34, the drive piece 32 is driven to rotate by the latch bolt 312 and the drive piece 32 sticks in the actuation section 413, and the user pulls the key 34 out of the keyhole 311 in the end, the locking operation is completed. A reverse action would be done to unlock it. First the user inserts the key 34 into the keyhole 311 and rotates reversely to unlock the lock barrel 31, the drive piece 32 is driven to rotate by the latch bolt 312, the actuation groove 322 of the drive piece 32 is rotated to face the actuation section 413 (as shown in FIG. 5), the drive piece 32 does not stick in the latch 41 and the second spring 43 presses the fixing bolt 416 by its elasticity to let the latch 41 move downwards, so the pressing section 412 of the latch 41 sticks out of the bottom of the latch barrel 42, at this time, the clip section 411 of the latch 41 moves back in the latch insertion hole 210 and does not fasten the trailer coupler 5, the flange 51 of the trailer coupler 5 could be moved away from the rabbet 211 of the fitting portion 21, and the unlocking operation is completed.

The horizontal lock barrel holder 23 of the present invention is configured in the horizontal direction, the key 34 may be provided to insert into the keyhole 311 on the outer end of the lock barrel 31 easily in the horizontal direction, so it is convenient for use.

The present invention has already solved the drawback of the conventional structure using a steel ball for catching that may cause shaking effect if it is impacted by external force, therefore, the pickproof function of trailer locks could be effectively improved, to thereby improve the anti-theft capability

What is claimed is:

1. A trailer lock structure, which includes:
a body, a fitting portion is set on its upper side, a latch insertion hole and a rabbet are set on the fitting portion, a latch mounting base and a horizontal lock barrel holder are set on the lower side of the body, a first fitting hole is set on the latch mounting base, the first fitting hole is communicated with the latch insertion hole, a second fitting hole is set on the horizontal lock barrel holder;
a lock barrel set, which is fit in the second fitting hole, the lock barrel set includes a lock barrel, a drive piece and a first spring, a keyhole is set on the outer end of the lock barrel, the keyhole is provided for a key to insert into for unlocking operation, a latch bolt is set on the inner end of the lock barrel, the latch bolt is connected to one end of the drive piece and drives the drive piece to rotate, the other end of the drive piece is pressed by the elasticity of the first spring;
a latch set, which is set in the first fitting hole, the latch set includes a latch, a latch barrel and a second spring; a clip section is set on the upper end of the latch; a limiting section, an actuation section and a pressing section are sequentially set below the clip section; a horizontal hole is set on the limiting section for one end of a fixing bolt to insert into and fix, the actuation section is used to place the drive piece and link up with it; a through hole and a spring mounting hole are set on the latch barrel, the through hole is used to place the latch, the spring mounting hole is used to place the second spring, the bottom end of the second spring is pressed on the fixing bolt.

2. The trailer lock structure as claimed in claim 1, wherein a fitting slot is set on one end of the drive piece, the fitting slot is connected to the latch bolt.

3. The trailer lock structure as claimed in claim 1, wherein an actuation groove is set on the drive piece.
